(19) United States
(12) Patent Application Publication
(10) Pub. No.: US 2006/0049344 A1
(43) Pub. Date: Mar. 9, 2006

(54) Laser scanning device

(75) Inventor: Toshio Kasai, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/217,481

(22) Filed: Sep. 2, 2005

(30) Foreign Application Priority Data
Sep. 3, 2004 (JP) 2004-256541

(51) Int. Cl. H01J 3/14; H01J 5/16

(52) U.S. Cl. 250/234

(57) ABSTRACT

A laser scanning device is provided. The laser scanning device includes a light source that emits light, a scanning unit that scans the light from the light source to form a beam scanning in a predetermined direction, a first light receiving unit that receives a portion of the light from the light source to generate a first light reception signal when the portion of the light is received, and a second light receiving unit that receives the beam emerged from the scanning unit to generate a second light reception signal when the beam is received. The first and second light receiving units are integrally formed with the light source.

### INCORPORATION BY REFERENCE

This application claims priority of Japanese Patent Application No. 2004-256541, filed on Sep. 3, 2004, the entire subject matter of the application being incorporated herein by reference.

### BACKGROUND OF THE INVENTION

The present invention relates to a laser scanning device capable of forming a beam spot scanning on a scan target surface.

The laser scanning devices of this type have been widely used. An example of such a laser scanning device is disclosed, for example, in Japanese Utility Model Publication No. 2601248. FIG. 10 is a perspective view illustrating a configuration of a laser scanning device 90 disclosed in the publication.

As shown in FIG. 10, the laser scanning device 90 includes a light source unit 72A, a collimator lens 73, a polygonal mirror 75, and an fθ lens 76. A laser beam emitted by the light source unit 72A is converted into a collimated beam by the collimator lens 73, and is deflected by the polygonal mirror 75 about its rotation axis rotating at high angular velocity. Then, the beam deflected by the polygonal mirror 75 passes through the fθ lens 76 to scan in a main scanning direction on the scan target surface. In the laser scanning device shown in FIG. 10, the beam emerged from the fθ lens 76 is reflected downward by a mirror 77 and passes through a slit 78. The slit 78 is formed through a bottom wall 71b of a housing 71 in which the components are accommodated. A photoconductive drum (not shown) as the scan target surface is located under the slit 78 so that an outer circumferential surface of the photoconductive drum is scanned by the beam scanning in the main scanning direction. By rotating the photoconductive drum, the outer circumferential surface of the photoconductive drum moves perpendicularly to the main scanning direction. Consequently, a two-dimensional latent image can be formed on the photoconductive drum.

In the laser scanning device 90, a mirror 80 is located at an end portion in a range of the deflection by the polygonal mirror 75 so that the beam which impinges on the mirror 80 is detected by a beam detector 9A. The beam detector 9A and the light source unit 72A are electrically connected to each other via a flat cable 81. In the laser scanning device 90, by using a reception signal outputted by the beam detector 9A which detects the beam reflected by the mirror 80, the timing control for light emission of the light source unit 72A is performed.

By using the laser scanning device 90 together with the photoconductive drum and other components, a laser printer can be formed.

It becomes necessary to use a plurality of laser scanning devices corresponding to three primary colors for forming a color laser printer, and each laser scanning device is required to be downsized or the thickness of each laser scanning device required to be reduced to downsize the color laser printer. The number of components of each laser scanning device is also required to be reduced for the reduction of manufacturing cost of the color laser printer. An example of a color laser printer is disclosed in Japanese Patent Provisional Publication No. 2000-122355.

In the laser scanning device 90, the beam detection is accomplished by two separate components (i.e., the mirror 80 and the beam detector 9A). Therefore, it is necessary to secure space for the mirror 80 and a sensor unit 82 on which the beam detector 9A is fixed in each laser scanning device 90. Such a configuration of the laser scanning device 90 increases the number of components and manufacturing cost, and also requires to secure space for the components in each laser scanning device. In this case, the downsizing of the laser scanning device (i.e., the laser printer) can not be attained.

It should be understood that although a board for the sensor unit 82 and a board for the light source unit 72A are vertically oriented respectively in the laser scanning device 90 shown in FIG. 10, if each board is horizontally oriented for the reduction of the thickness of the laser scanning device, an area required for arranging the boards increases.

### SUMMARY OF THE INVENTION

The present invention is advantageous in that it provides an laser scanning device which makes it possible to reduce manufacturing cost and to attain downsizing in regard to a structure for detection of a beam for the control of beam emission timing of a light source.

According to an aspect of the invention, there is provided a laser scanning device, which is provided with a light source that emits light, a scanning unit that scans the light from the light source to form a beam scanning in a predetermined direction, a first light receiving unit that receives a portion of the light from the light source to generate a first light reception signal when the portion of the light is received, and a second light receiving unit that receives the beam emerged from the scanning unit to generate a second light reception signal when the beam is received. The first and second light receiving units are integrally formed with the light source.

Since the light source and the first and second light receiving units are integrally formed, it is possible to downsize the laser scanning device and to reduce the manufacturing cost of the laser scanning device.

In a particular case, the first and second light receiving units and the light source may be integrally formed on a single circuit board.

In a particular case, the first and second light receiving units and the light source may be integrally formed on a single chip.

Optionally, the laser scanning device may include a deflector that is located within a scanning range of the beam, and deflects the beam impinging thereon so that the beam is received by the second light receiving unit.

In a particular case, the deflector may include a mirror.

Still optionally, the laser scanning device may include a light guide that receives the beam from the deflector so as to guide the beam to the second light receiving unit.

In a particular case, the light guide may include an optical fiber.

Still optionally, the laser scanning device may include a prism that receives the beam from the deflector so as to direct the beam to the second light receiving unit.

Still optionally, the prism may have a cylindrical surface serving as a reflection surface which reflects the beam coming from the deflector toward the second light receiving unit.

Still optionally, the laser scanning device may include a controller that controls an output level of the light source based on the first light reception signal, and controls timing of light emission of the light source based on the second light reception signal. The controller may be integrally formed with the light source.

Still optionally, the laser scanning device may include a single photoreceptor. In this case, the single photoreceptor may be shared by the first and second light receiving units so that both of the portion of the light from the light source and the beam emerged from the scanning unit are received by the single photoreceptor.

Still optionally, the first light receiving unit may include a first comparator that compares an output level of the single photoreceptor with a first reference voltage to generate the first light reception signal, and the second light receiving unit may include a second comparator that compares the output level of the single photoreceptor with a second reference voltage to generate the second light reception signal.

Still optionally, the second reference voltage may be higher than the first reference voltage.

In a particular case, the single photoreceptor may be a photodiode.

In a particular case, the portion of the light from the light source may be directly received by the single photoreceptor.

Optionally, the laser scanning device may include a controller that controls an output level of the light source based on the first light reception signal, and controls timing of light emission of the light source based on the second light reception signal. In this case, the light source, the first light receiving unit, the second light receiving unit, the single photoreceptor, and the controller may be integrally formed on a single chip.

In a particular case, the single chip may be sealed in a single package.

In a particular case, the package may be a flat package.

In a particular case, the single circuit board may be oriented horizontally in the laser scanning device.

### BRIEF DESCRIPTION OF THE ACCOMPANYING DRAWINGS

FIG. 1 is a perspective view illustrating a configuration of a laser scanning device according to a first embodiment;

FIG. 2 is a perspective view illustrating a configuration of a laser driving unit provided in the laser scanning device;

FIG. 3A is a top view of an integrated laser driver IC illustrating an internal configuration of the integrated laser driver IC;

FIG. 3B is a cross-sectional view of the integrated laser driver IC along a line A-A in FIG. 3A;

FIG. 4 is a circuit block diagram of the laser driving unit and a controller 13 which are electrically connected to each other;

FIG. 5 is a timing chart illustrating an image forming operation and an automatic power controlling operation performed by the laser driving unit and the controller;

FIG. 6 is a perspective view of a laser scanning device according to a second embodiment;

FIG. 7 is a perspective view illustrating a configuration of the laser driving unit according to the second embodiment;

FIG. 8A is a top view of an integrated laser driver IC according to the second embodiment illustrating an internal configuration thereof;

FIG. 8B is a cross-sectional view of the integrated laser driver along a line B-B in FIG. 8A;

FIG. 9 schematically shows an arrangement of a prism and a photodiode when these components is viewed from the front side of the integrated driver IC; and

FIG. 10 is a perspective view illustrating a configuration of a conventional laser scanning device.

### DETAILED DESCRIPTION OF THE EMBODIMENTS

Hereinafter, embodiments according to the invention are described with reference to the accompanying drawings.

### First Embodiment

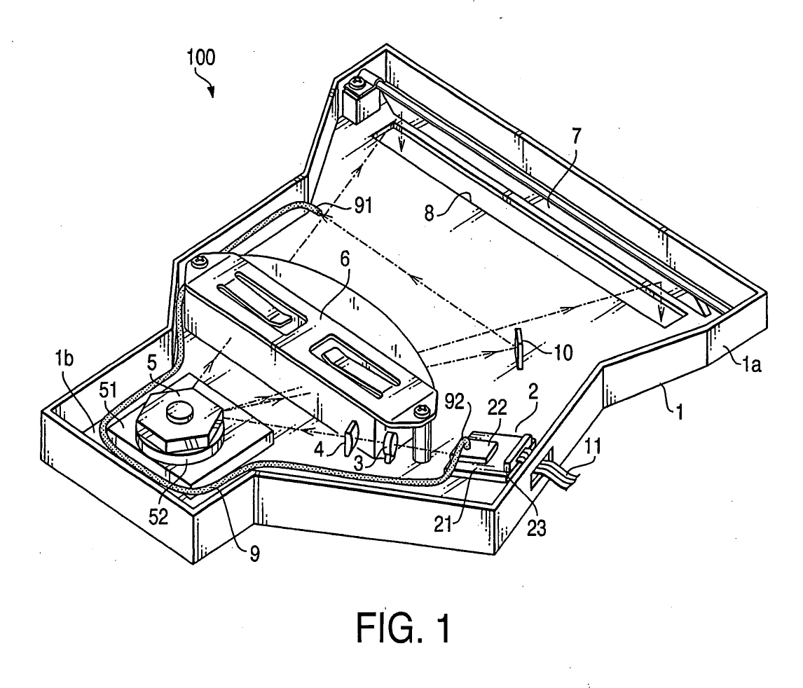

FIG. 1 is a perspective view illustrating a configuration of a laser scanning device 100 according to a first embodiment of the invention. The laser scanning device 100 has a housing 1 with which a side wall 1a is integrally formed. A laser driving unit 2, a collimator lens 3, a cylindrical lens 4, a polygonal mirror 5, an fθ lens 6 are accommodated in the housing 1.

The polygonal mirror 5 has a form of a polygonal column. That is, the polygonal mirror 5 has a polygonal (e.g., hexagonal or octagonal) shape in a plan view. The polygonal mirror 5 is mounted on a board 51 via a motor 52 so that the polygonal mirror 5 is rotated by the motor 52 in a plane parallel with a surface of the board 51. The board 51 is fixed on a bottom wall 1b of the housing 1. Therefore, the polygonal mirror 5 rotates in a plane parallel with the bottom wall 1b of the housing 1.

The laser driving unit 2, the collimator lens 3 and the cylindrical lens 4 are located along a common optical axis. As described in detail later, the laser driving unit 2 is provided with a semiconductor laser (i.e., a laser diode) and is configured to control the laser beam emission from the laser diode by detecting a portion of the laser beam emitted by the laser diode.

In this specification, a direction in which the beam spot moves (i.e., a direction in which a scanning line extends) will be referred to as a main scanning direction. Further, a direction in which a scan target surface moves with respect to the scanning line, e.g., a rotation direction of a photoconductive drum which may be located under the laser scanning device 100 will be referred to as an auxiliary scanning direction. The shapes of optical elements, directions of powers of the optical elements and the like are described with reference to the main and auxiliary scanning directions on the scan target surface. That is, if an optical element is described to have a refractive power in the main scanning direction, the power affects the beam in the main scanning direction on the scan target surface regardless of the orientation of the element.

The beam emitted by the laser driving unit 2 is collimated by the collimator lens 3, and the collimated beam is converged by the cylindrical lens 4 in the auxiliary scanning direction so that a converging beam is incident on a reflection surface of the polygonal mirror 5. The polygonal mirror 5 deflects the beam in a predetermined angular range.

The fθ lens 6 is located so that the beam deflected in the predetermined angular range by the polygonal mirror 5 passes therethrough. The fθ lens 6 has the function of converting the velocity of the beam spot moving in the main scanning direction on the scan target surface to a constant speed. On the beam emerging side of the fθ lens 6 in the housing 1, a reflection mirror 7 having a shape extending along the main scanning direction is located. A slit 8 having a shape extending along the main scanning direction is also formed in the bottom wall 1b beneath the reflection mirror 7.

The photoconductive drum is located under the slit 8 so that the beam passed through the slit 8 scans on an outer circumferential surface of the photoconductive drum in the main scanning direction. By rotating the photoconductive drum about its rotational axis, the scan target surface (a photoconductive surface) moves in the auxiliary scanning direction. Therefore, a two-dimensional latent image can be formed on the photoconductive surface.

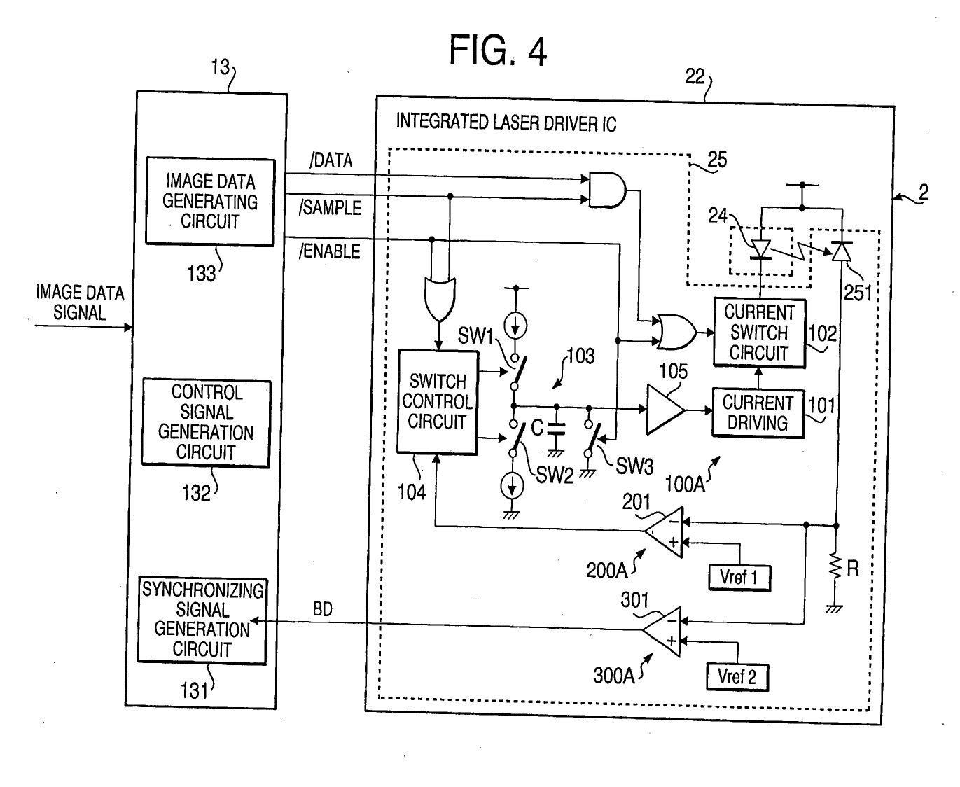

As shown in FIG. 1, a mirror 10 is located at an end portion of a scanning range of the beam deflected by the polygonal mirror 5. The mirror 10 is oriented so that the beam reflected by the mirror 10 proceeds in a horizontal plane to one end face 91 of an optical fiber 9 located near the other end portion of the scanning range. The optical fiber 9 is installed in the housing 1 so that the other end face 92 is optically connected to the laser driving unit 2. The laser driving unit 2 is electrically connected to a controller 13 (see FIG. 4) via a cable 11.

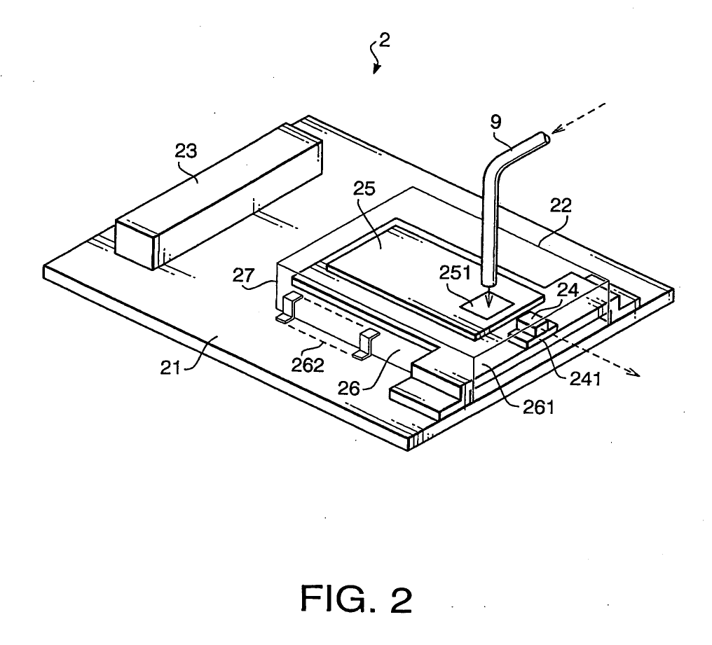

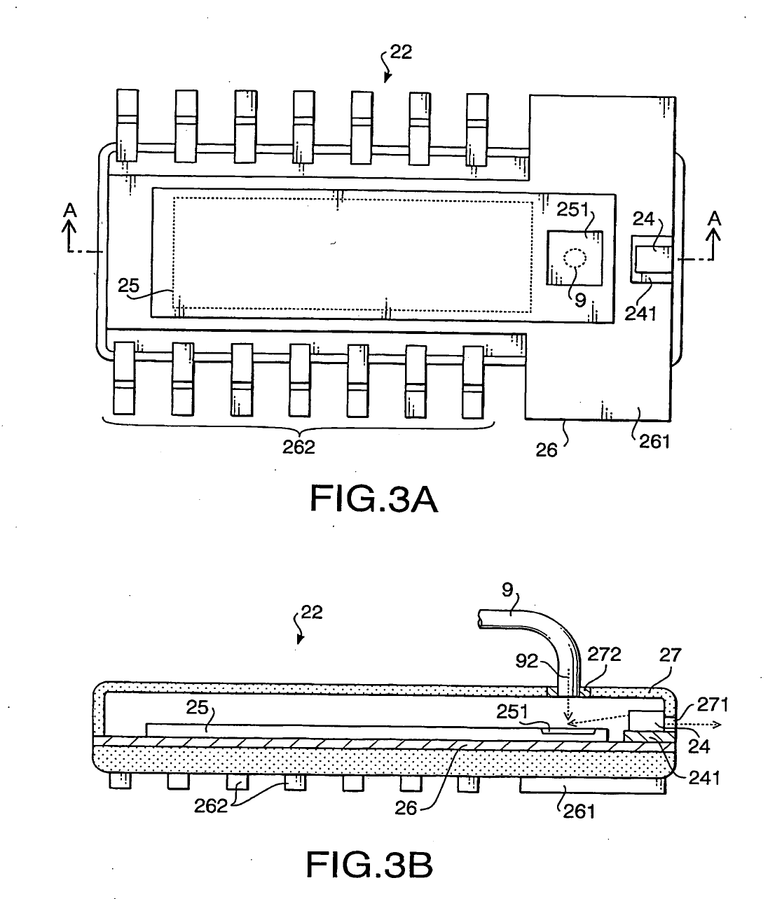

FIG. 2 is a perspective view illustrating a configuration of the laser driving unit 2. As shown in FIG. 2, the laser scanning unit 2 includes a circuit board 21 on which an integrated laser driver IC 22 and a connector 23 are mounted. In the integrated laser driver IC 22, a laser driving circuit, a laser detecting circuit and a controlling circuit are integrated. FIG. 3A is a top view of the integrated laser driver IC 22 illustrating an internal configuration of the integrated laser driver IC 22. FIG. 3B is a cross-sectional view of the integrated laser driver IC 22 along a line A-A in FIG. 3A.

As shown in FIGS. 3A and 3B, the integrated laser driver IC 22 is configured such that a laser diode chip (hereafter, frequently referred to as a laser diode) 24 and a monolithic controller chip (hereafter, frequently referred to as a controller) 25 are integrally mounted on a lead frame 26 in a package 27. The laser diode chip 24 is mounted on the lead frame 26 via a mount 241.

In the integrated laser driver IC 22, the controller 25 and the laser diode 24 are electrically connected to each other so that the controller 25 can control the laser emission of the laser diode 24. A transparent window 271 is formed in a side wall of the package 27 so that the laser beam emitted by the laser diode 24 can emerge from the package 27 via the transparent window 271.

A portion of the lead frame 26 is formed as a heat sink 261 thermally coupled to the laser diode 24. The integrated laser driver IC 22 is formed as a SOP (small outline package) having leads 262, and is mounted on a surface of the circuit board 21. The integrated laser driver IC 22 is electrically connected to the connector 23 via patterns formed in the circuit board 21.

A photodiode 251, which is a monolithic type chip, is formed integrally with the controller 25 at a position near to the laser diode 24. In this structure, the photodiode 251 receives monitor light from the laser diode 24. Specifically, the photodiode 251 receives light emitted from a surface of the laser diode 24 opposite to a light emission surface facing the transparent window 271.

A light reception window 272 is opened through a top wall of the package 27. The end face 92 is fixed to the package 27, for example, by a resin, in a state that the end face 92 is inserted in the light reception window 272. With this structure, the photodiode 251 receives light propagated through the optical fiber 9.

The laser driving unit 2 is fixed to the bottom wall 1b of the housing 1 by use of fixing members. In an assembling process of the laser scanning device 100, the height and orientation of the laser driving unit 2 is adjusted such that an center axis of the laser beam emerging from the laser driving unit 2 coincides with an optical axis of the collimator lens 3 and the cylindrical lens 4, and then the flat cable 11 is connected to the laser driving unit 2 and to the controller 13.

FIG. 4 is a circuit block diagram of the laser driving unit 2 and the controller 13 which are electrically connected to each other via the flat cable 11. As shown in FIG. 4, a laser driving circuit 100A, a light intensity detecting circuit 200A and a BD detection circuit 300A are formed in the controller chip 25, together with the photodiode 251. In the light intensity detecting circuit 200A, a voltage generated by a resistance R when photodiode 251 receives laser light is compared with a first reference voltage Vref1 by a comparator 201. The comparator 201 outputs a light intensity signal indicating whether the voltage generated by the resistance R is higher than the first reference voltage Vref1. The light intensity signal is inputted to the laser driving circuit 100A.

A voltage generated by the register R when the photodiode 251 receives laser light from the end face 92 is compared with a second reference voltage Vref2 by a comparator 301. The comparator 301 outputs a BD signal indicating timing of the reception of laser light generated as a result of the comparison. The BD signal generated by the comparator 301 is inputted to controller 13.

As shown in FIG. 4, the controller 13 includes a synchronizing signal generation circuit 131, a control signal generation circuit 132 and an image data generating circuit 133. The synchronizing signal generation circuit 131 operates to generate a synchronizing signal in response to the BD signal. The control signal generation circuit 132 operates to generate an enabling signal /ENABLE for controlling a current switch circuit 102 and a reset switch SW3 and to generate, with reference to the synchronizing signal, a sampling signal /SAMPLE for controlling a switch control circuit 104 and the current switch circuit 102. The image data generating circuit 133 operates to generate an image data signal /DATA based on image data inputted to the controller 13 from an external device. The image data signal /DATA is in synchronization with the BD signal.

The laser driving circuit 100A includes a current driving circuit 101, the current switch circuit 102 and an APC (automatic power controlling) circuit 103. The current driving circuit 101 supplies the current to the laser diode 24 so as to make the laser diode 24 emit the laser beam. The current switch circuit 102 operates to modulate the driving current from the circuit 101 by on/off controlling the driving current so as to form an image. The APC circuit 103 operates to bring the level of the driving current from the circuit 101 to a constant level.

More specifically, the APC circuit 103 includes the switch control circuit 104, the reset switch SW3 and an amplifier 105. The switch control circuit 104 operates to control on/off states of a switch SW1 functioning to charge a capacitor C and a switch SW2 functioning to discharge the capacitor C, based on the light intensity signal from the comparator 201. The reset switch SW3 is used to forcibly discharge the capacitor C. The amplifier 105 functions as a buffer for transmitting the output of the capacitor C to the current driving circuit 101.

The operation of the APC circuit 103 is controlled by controlling the switch control circuit 104 by the /ENABLE signal and the /SAMPLE signal and by controlling the reset switch SW3 by the /ENABLE signal. The emission timing of the laser diode 24 is controlled by controlling the current switch circuit 102 by the /SAMPLE signal, the /ENABLE signal and the /DATA signal.

In the above mentioned configuration, the laser scanning device 100 operates as follows. The laser beam emitted by the laser diode 24 of the laser driving unit 2 is incident on the reflection surface of the polygonal mirror 5 via the collimator lens 3 and the cylindrical lens 4, and is deflected by the polygonal mirror 5. The beam deflected by the polygonal mirror 5 is then converted by the fθ lens 6 to the beam scanning on the scan target surface at a constant speed in the main scanning direction. In this situation, the laser light (i.e. the monitor light) emitted from the rear surface of the laser diode 24 is received by the photodiode 251, and a portion of the scanning beam is reflected by the mirror 10 when the beam impinges on the mirror 10 at one end portion of the scanning range. The beam reflected by the mirror 10 proceeds to enter the end face 91 of the optical fiber 9.

The beam entered into the optical fiber 9 from the end face 91 propagates through the optical fiber 9, emerges from the end face 92 and then impinges on the photodiode 251.

In the above mentioned image forming operation of the laser scanning device 100, the light intensity detecting circuit 200A outputs a detection signal when the voltage level of the resistance R indicating the intensity of the light received by the photodiode 251 becomes larger than the first reference voltage Vref1.

If the photodiode 251 receives the laser light emerged from the end face 92 of the optical fiber 9 in addition to the laser light emitted from the rear surface of the laser diode 24, an voltage level corresponding to the laser light emerged from the end face 92 of the optical fiber 9 is added to the voltage level corresponding to the laser light (the monitor light) from the laser diode 24. In the laser driving unit 2, the second reference voltage Vref2 is set larger than the first reference voltage level. Therefore, the state in which both of the monitor light and the laser light from the optical fiber 9 are incident on the photodiode 251 can be detected by the BD detection circuit 300A. In other words, the BD detection circuit 300A operates to detect only the emission of the laser light from the end face 92 of the optical fiber 9.

If the reception of the laser light from the optical fiber 9 is detected by the BD detection circuit 300A, the BD detection circuit 300A outputs the BD signal. In the controller 13, the synchronizing signal is generated by the synchronizing signal generation circuit 131 in accordance with the BD signal, and the /SAMPLE signal is generated by the control signal generation circuit 132 with reference to the synchronizing signal. The /SAMPLE signal is inputted to the laser driving circuit 100A.

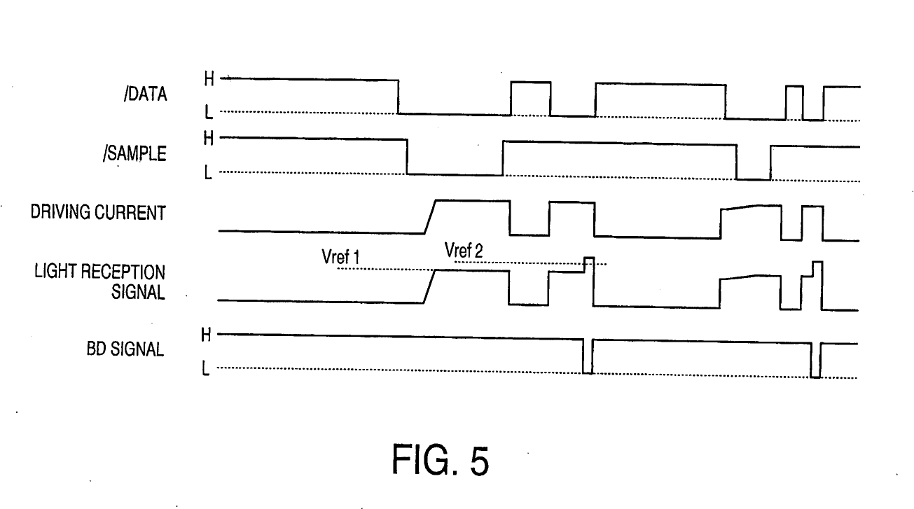

FIG. 5 shows an example of a timing chart illustrating the image forming operation and the automatic power controlling operation of the laser driving circuit 100A. In FIG. 5, the /DATA signal, the /SAMPLE signal, the driving current for the laser diode 24, the output level (a light reception signal) of the photodiode 251, and the BD signal are shown. When the /ENABLE signal is held “L” by the controller 13, the reset switch SW3 is turned to OFF so that the circuit 100A becomes ready for supplying current to the laser diode 24. In this state, if the /DATA signal enabling the emission of the laser beam of the laser diode 24 is held “L”, and the /SAMPLE signal is held “L”, the switch control circuit 104 starts to operate.

The switch control circuit 104 operates to switch the switch SW2 to ON when the output level of the light intensity detecting circuit 200A is low (i.e., when the voltage level of the photodiode 251 is higher than the first reference voltage Vref1), so that the charge level of the capacitor C decreases. The switch control circuit 104 operates to switch the switch SW1 to ON when the output level of the light intensity detecting circuit 200A is high (i.e., when the voltage level of the photodiode 251 is lower than the first reference voltage Vref1), so that the charge level of the capacitor C increases.

With this operation, the charge level of the capacitor C is controlled so that the output level of the laser diode 24 is kept at a constant level. In this state, the current switch circuit 102 operates to modulate the laser beam by on/off controlling the driving current in accordance with the /DATA signal, and the laser diode 24 is driven by the on/off modulated current. Consequently, the laser diode 24 is controlled its on/off state in accordance with the /DATA signal (i.e., image data) and the photoconductive drum is irradiated with the laser beam having the constant intensity level.

As described above, when a portion of the scanning beam impinges on the mirror 10, the output level of the photodiode 251 increases by an amount corresponding to the laser light emerging from the end face 92 of the optical fiber 9. The increased output level of the photodiode 251 is detected by the BD detection circuit 300A because the second reference voltage Vref2 is set higher than the first reference voltage Vref1. That is, the laser driving unit 2 is capable of detecting the laser beam reflected by the mirror 10 and outputting the BD signal indicating the reception timing of the laser light from the mirror 10. Therefore, it is possible to obtain timing information for controlling the emission of the laser beam of the laser diode 24.

As described above, according to the first embodiment, the photodiode 251 is used to obtain the BD signal enabling the controller 13 to control the timing of the scanning of the laser beam, in addition to using the photodiode 251 to receive the monitor light from the laser diode 24. Such a configuration of the laser scanning device 100 eliminates the need for employing a dedicated sensor for generating the BD signal. Therefore, according to the first embodiment, it is possible to decrease the number of components for the laser scanning device, and thereby to downsize the laser scanning device. Further, the manufacturing cost of the laser scanning device can be reduced.

### Second Embodiment

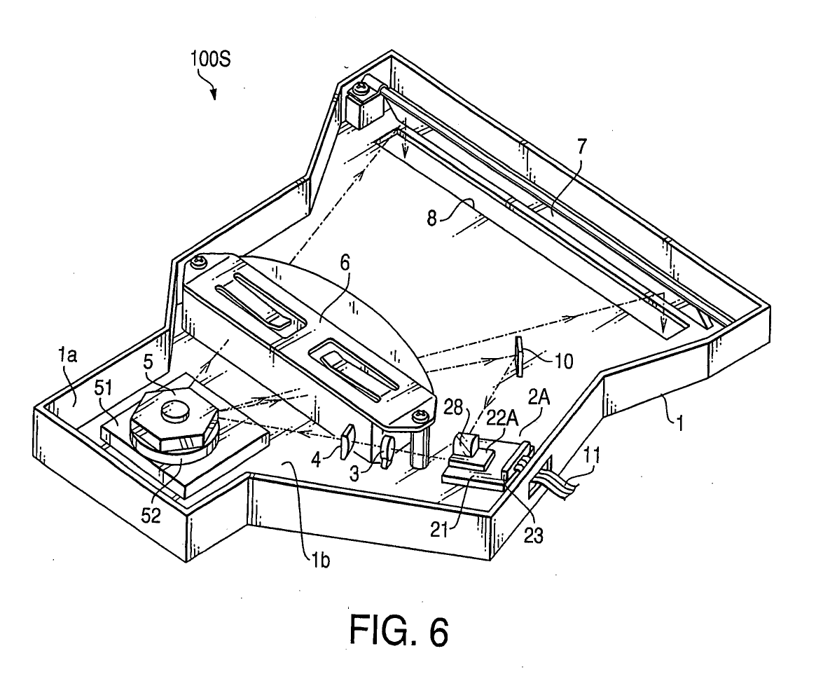

FIG. 6 is a perspective view of a laser scanning device 100S according to a second embodiment of the invention. In this embodiment, to elements which are substantially the same as those of the first embodiment, the same reference numbers are assigned, and explanations thereof will not be repeated. In the laser scanning device 100S, a laser driving unit 2A is used, and the laser beam reflected by the mirror 10 is detected by the laser driving unit 2A without employing the optical fiber 9. Therefore, the configuration of the laser scanning device is further simplified.

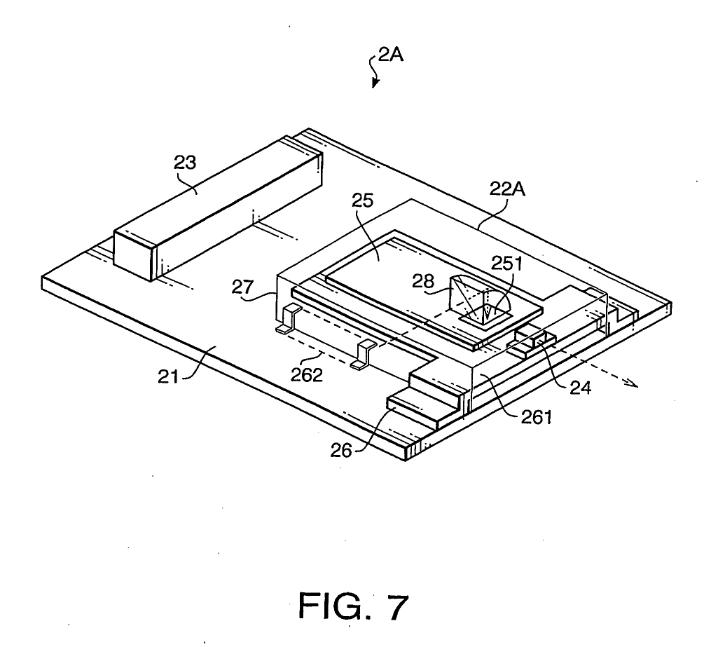

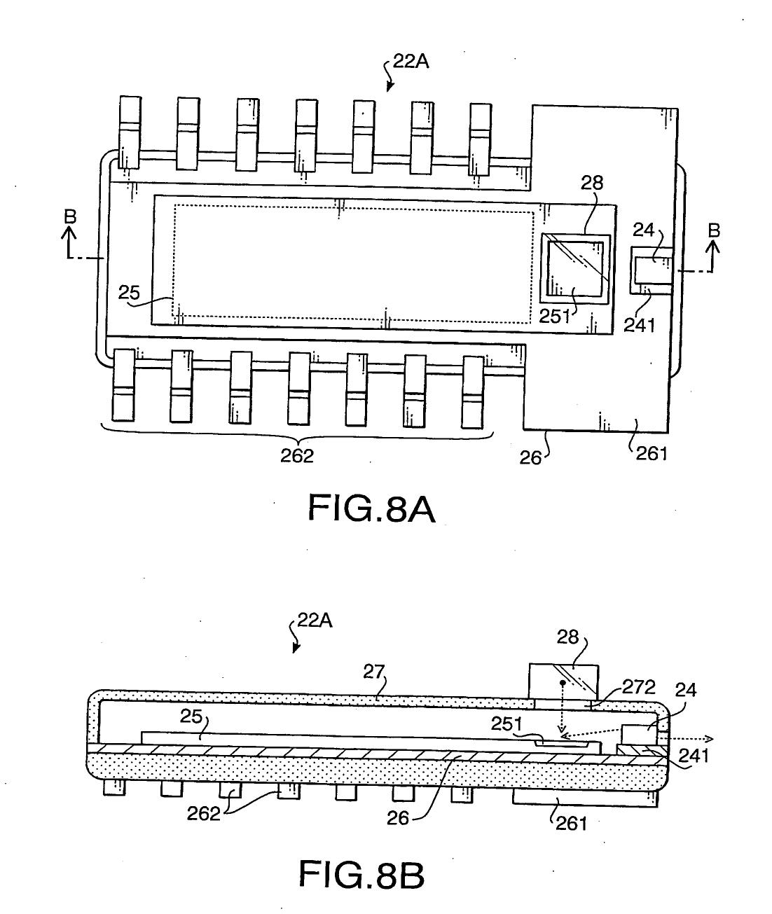

FIG. 7 is a perspective view illustrating the configuration of the laser driving unit 2A. FIG. 8A is a top view of an integrated laser driver IC 22A illustrating an internal configuration thereof. FIG. 8B is a cross-sectional view of the integrated laser driver IC 22A along a line B-B in FIG. 8A. The integrated laser driver IC 22A is provided with a prism 28 on its top surface. The prism 28 is fixed to the top surface of the package 27 to cover the light reception window 272 by use of an adhesive.

Specifically, the prism 28 is made of, for example, transparent resin or glass, and is configured to have a cylindrical surface 281 (corresponding to an oblique surface of a typical prism). The prism 28 directs the laser beam, which was reflected from the mirror 10, to a light reception surface of the photodiode 251 by internal reflection at the cylindrical surface 281. In the laser scanning device 100S, the orientation of the mirror 10 is adjusted such that the beam reflected from the mirror 10 proceeds to a front side of the prism 28.

In this embodiment only a structure for directing the laser beam, which reflects from the mirror 10, to the photodiode 251 is different from that of the first embodiment. Therefore, in the following, only the feature (i.e., the structure for directing the beam reflected from the mirror 10 to the photodiode 251) of the second embodiment will be explained.

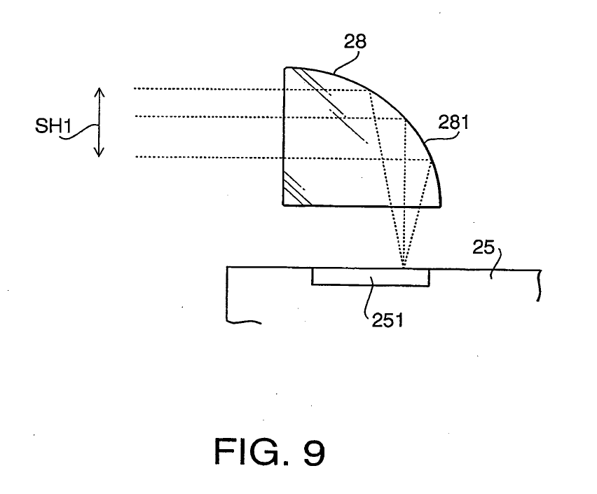

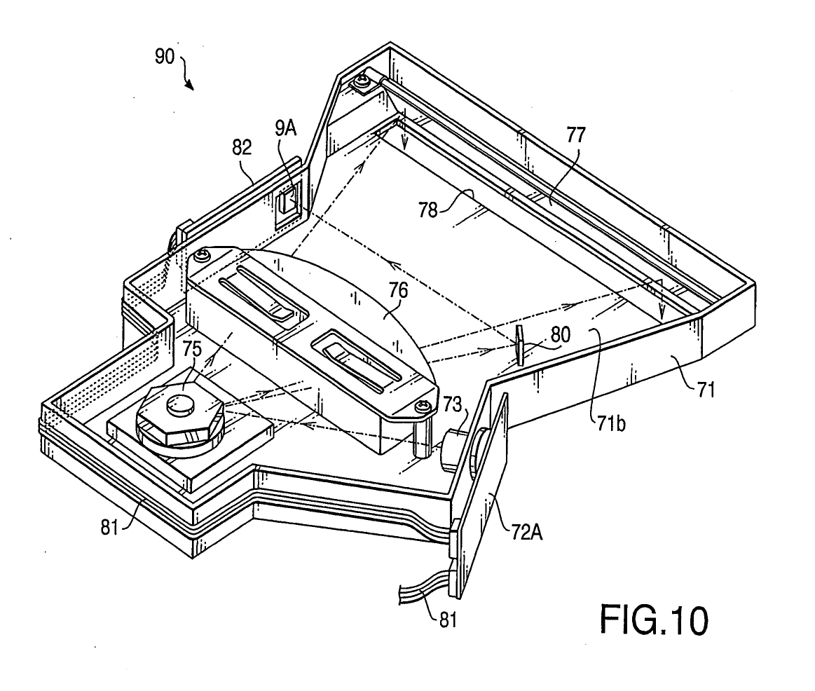

As shown in FIGS. 6 and 7, the beam reflected from the mirror 10 enters the prism 28 through the front side of the prism 28. FIG. 9 schematically shows the arrangement of the prism 28 and the photodiode 251 when these components is viewed from the front side of the IC 22A. As can be seen from FIG. 9, the laser beam from the mirror 10 enters the prism 28 through the front side and is reflected downwardly by an inner surface of the cylindrical surface 281 so as to be incident on the photodiode 251.

Since the photodiode 251 receives the monitor light from the laser diode 24 (see FIG. 8B), the output level of the photodiode 251 becomes the sum of the voltage level corresponding to the laser beam from the mirror 10 and the voltage level corresponding to the monitor light when the photodiode 251 receives the laser beam from the mirror 10. Accordingly, the image forming operation and the automatic power controlling operation as well as the generation of the BD signal described with reference to FIGS. 4 and 5 in the first embodiment can also be attained in this embodiment.

As shown in FIG. 9, since the surface from which the laser beam coming from the mirror 10 is reflected is formed as a cylindrical surface, even if an optical path of the laser beam from the mirror 10 is shifted, an incident point at which the laser beam reflected from the cylindrical surface 281 impinges on the photodiode 251 can be kept unchanged. Such a structure contributes to the stabilization of the output level of the photodiode 251. In FIG. 9, the shift of the optical path (shown by a dashed line) is represented by an arrow SH1.

As described above, according to the second embodiment, the photodiode 251 is used to obtain the BD signal enabling the controller 13 to control the timing of the scanning of the laser beam, in addition to using the photodiode 251 to receive the monitor light from the laser diode 24. Such a configuration of the laser scanning device eliminates the need for employing a dedicated sensor for generating the BD signal. In addition, the second embodiment eliminates the need for using the optical fiber. Therefore, according to the second embodiment, the advantages described in the first embodiment can be enhanced.

Although the present invention has been described in considerable detail with reference to certain preferred embodiments thereof, other embodiments are possible.

In the above mentioned embodiments, the photodiode 251 is used both as a photodiode for receiving monitor light of a laser source and as a photodiode for receiving a portion of a scanning beam. However, two separate photodiodes (a first photodiode for receiving monitor light of a laser source and as a second photodiode for receiving a portion of a scanning beam) may be employed in the laser scanning device. In this case, the first and second photodiodes may be integrally formed on a single chip, or may be formed as two separate chips.

One of the first and second photodiodes may be integrally formed with the laser driving circuit 100A on a single chip (i.e., the controller chip 25). One of the first and second photodiodes may be formed as a discrete package. If the first and second photodiode are formed as separate parts, these parts may be mounted on a single circuit board.

In the above mentioned embodiment, the laser driving circuit 100A, the light intensity detecting circuit 200A and the BD detection circuit 300A are integrally formed as a single chip. However, these circuits may be formed as separate chips. The elements formed on the controller chip 25 may be divided into a plurality of chips.

A deflecting member for deflecting light, such as, a mirror or a diffraction grating, may be used in place of the prism 28.

In the second embodiment, the circuit board 21 is oriented horizontally with respect to the bottom wall 1b of the housing 1. However, the circuit board 21 may be oriented vertically with respect to the bottom wall 1b if the reduction of the height of the laser scanning device is not an essential requirement. In this case, it is possible to direct the laser beam reflected from the mirror 10 directly to the top surface of the integrated laser driver IC 22 (i.e., to the light reception window 272). Also, in this case, the prism 28 may be replaced with a lens (e.g., a cylindrical lens) so that an incident point, at which the beam passed through the lens impinges on the photodiode 251, can be kept unchanged even if the optical path proceeding from the mirror 10 to the integrated laser driver IC 22 is shifted. Consequently, the output level of the photodiode can be stabilized.

What is claimed is:

1. A laser scanning device, comprising:
a light source that emits light;
a scanning unit that scans the light from the light source to form a beam scanning in a predetermined direction;
a first light receiving unit that receives a portion of the light from the light source to generate a first light reception signal when the portion of the light is received; and
a second light receiving unit that receives the beam emerged from the scanning unit to generate a second light reception signal when the beam is received;
wherein the first and second light receiving units are integrally formed with the light source.

2. The laser scanning device according to claim 1, wherein the first and second light receiving units and the light source are integrally formed on a single circuit board.

3. The laser scanning device according to claim 1, wherein the first and second light receiving units and the light source are integrally formed on a single chip.

4. The laser scanning device according to claim 1, further comprising a deflector that is located within a scanning range of the beam, and deflects the beam impinging thereon so that the beam is received by the second light receiving unit.

5. The laser scanning device according to claim 4, wherein the deflector includes a mirror.

6. The laser scanning device according to claim 4, further comprising a light guide that receives the beam from the deflector so as to guide the beam to the second light receiving unit.

7. The laser scanning device according to claim 6, wherein the light guide includes an optical fiber.

8. The laser scanning device according to claim 4, further comprising a prism that receives the beam from the deflector so as to direct the beam to the second light receiving unit.

9. The laser scanning device according to claim 8, wherein the prism has a cylindrical surface serving as a reflection surface which reflects the beam coming from the deflector toward the second light receiving unit.

10. The laser scanning device according to claim 1, further comprising a controller that controls an output level of the light source based on the first light reception signal, and controls timing of light emission of the light source based on the second light reception signal,
wherein the controller is integrally formed with the light source.

11. The laser scanning device according to claim 1, further comprising a single photoreceptor,
wherein the single photoreceptor is shared by the first and second light receiving units so that both of the portion of the light from the light source and the beam emerged from the scanning unit are received by the single photoreceptor.

12. The laser scanning device according to claim 11, wherein:
the first light receiving unit includes a first comparator that compares an output level of the single photoreceptor with a first reference voltage to generate the first light reception signal;
the second light receiving unit includes a second comparator that compares the output level of the single photoreceptor with a second reference voltage to generate the second light reception signal; and
the second reference voltage is higher than the first reference voltage.

13. The laser scanning device according to claim 11, wherein the single photoreceptor is a photodiode.

14. The laser scanning device according to claim 11, wherein the portion of the light from the light source is directly received by the single photoreceptor.

15. The laser scanning device according to claim 11, further comprising a controller that controls an output level of the light source based on the first light reception signal, and controls timing of light emission of the light source based on the second light reception signal,
wherein the light source, the first light receiving unit, the second light receiving unit, the single photoreceptor, and the controller are integrally formed on a single chip.

16. The laser scanning device according to claim 15, wherein the single chip is sealed in a single package.

17. The laser scanning device according to claim 16, wherein the package is a flat package.

18. The laser scanning device according to claim 2, wherein the single circuit board is oriented horizontally in the laser scanning device.
